(19) United States
(12) Patent Application Publication
(10) Pub. No.: US 2007/0241658 A1
(43) Pub. Date: Oct. 18, 2007

(54) Image Display and Method for Manufacturing Same

(75) Inventors: Tsuyoshi Oyaizu, Kanagawa-ken (JP); Hitoshi Tabata, Kanagawa-ken (JP); Isamu Tsuchiya, Gunma-ken (JP); Takeo Ito, Saitama-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 10/590,324

(22) PCT Filed: Feb. 15, 2005
(86) PCT No.: PCT/JP05/02238

§ 371 Date: Aug. 23, 2006

(30) Foreign Application Priority Data
Feb. 23, 2004 (JP) 2004-046588

(51) Int. Cl. H01J 1/62; H01J 9/00; H01J 17/24; H01J 61/26

(52) U.S. Cl. 313/495; 445/24; 313/553; 313/549

(57) ABSTRACT

An image display device includes a face plate in which a metal back layer is formed on a phosphor screen and a rear plate having a number of electron emitting elements, and an electrically divided portion is formed at the metal back layer in a predetermined pattern. In this electrically divided portion, a covering layer including a component melting or oxidizing a metal (Al) and heat resistant fine particles such as silica fine particles respectively, and having concaves and convexes resulting from the heat resistant fine particles on a surface thereof is formed. Besides, a getter layer divided by the covering layer is formed on the metal back layer in a film shape. It is desirable that in the light absorption layer, a portion at least positioning at a lower layer of the divided portion of the metal back layer has a surface resistance of 1×10⁵Ω/□ to 1×10¹²Ω/□.

### TECHNICAL FIELD

The present invention relates to an image display device such as a field emission display (FED), and a manufacturing method of the image display device.

### BACKGROUND ART

Conventionally, a phosphor surface in metal-back type having a metal film formed on a phosphor layer is used in an image display device such as a cathode-ray tube (CRT) and an FED. The metal film (metal back layer) in this type is formed so as to enhance brightness by reflecting a light proceeding to an electron emission source side, in the light emitted from a phosphor by an electron emitted from the electron emission source toward a face plate side, and to play a role of an anode electrode by supplying a phosphor layer with conductivity, and so on.

In a thin image display device such as the FED, a gap between the face plate having a phosphor screen (the phosphor layer and the metal back layer) and a rear plate having electron emission elements is extremely narrow being 1 mm to several mm, and there is a problem that a discharge (vacuum-arc discharge) may easy to occur at an electric field concentration portion between the face plate and the rear plate.

Conventionally, the metal back layer being a conductive film has been divided into several blocks to provide gaps at the divided portions so as to improve a voltage resistance characteristic and to reduce a damage when the above-stated discharge is generated (for example, refer to Patent Document 1).

However, in the image display device having the divided metal back layers, there are problems that not only it is difficult to control a resistance value of the divided portion, but also the discharge may be generated because end portions of the metal back layers at both sides of the divided portions have sharp shapes, and therefore, an electric field is concentrated at these acute angle portions.

Besides, in recent years, it is examined to form a layer of a getter material within an image display region so as to absorb a gas emitted from an inside wall of a vacuum envelope, in a plane image display device. A structure in which a thin film of the getter material having conductivities such as titanium (Ti), zirconium (Zr) is formed on the metal back layer is proposed (for example, refer to Patent Document 2).

In the image display device having the getter layer on the metal back layer as stated above, a structure in which the getter layer divided by providing an overcoat layer in a laminated structure is provided to suppress the generation of discharge and to improve the voltage resistance characteristic is proposed (for example, refer to Patent Document 3).

However, in the image display device described in the Patent Document 3, not only a forming process of the overcoat layer is complicated, but also it is difficult to realize a stable and fine voltage resistance characteristic.
Patent Document 1: JPA 2000-311642 (KOKAI) (page 2 to page 3, FIG. 3)
Patent Document 2-JP-A 9-82245 (KOKAI) (page 2 to page 4)
Patent Document 3: JP-A 2003-68237 (KOKAI) (page 2 to page 3)

### DISCLOSURE OF THE INVENTION

The present invention has been made to solve these problems, and an object thereof is to provide an image display device in which a voltage resistance characteristic is drastically improved, a destruction, deterioration of electron emission elements and a phosphor surface caused by an abnormal discharge are prevented, and a display with high brightness and high quality is possible.

An image display device of the present invention comprises a face plate having a phosphor screen including a light absorption layer and a phosphor layer which are formed in a predetermined pattern on a glass substrate, and a metal back layer formed on the phosphor screen, and a rear plate having a number of electron emission elements formed on a substrate, and disposed to face the face plate, wherein the metal back layer includes an electrically divided portion formed in a predetermined pattern, a covering layer containing a component melting or oxidizing a metal material composing the metal back layer and heat resistant fine particles respectively, and having concaves and convexes at a surface resulting from the heat resistant fine particles, is formed in the divided portion, and a getter layer divided by the covering layer is formed on the metal back layer in a film shape.

A manufacturing method of an image display device of the present invention comprises forming a phosphor screen in which a light absorption layer and a phosphor layer are arranged in a predetermined pattern at an inner surface of a face plate, forming a metal back layer by for ing a metal film on the phosphor screen, forming a vacuum envelope including the face plate, and disposing an electron emission source inside of the vacuum envelope to face the phosphor screen, wherein the manufacturing method of the image display device includes forming a covering layer containing a component melting or oxidizing the metal film and heat resistant fine particles respectively at a predetermined region on the metal back layer composed of the metal film, and removing or increasing a resistance of the metal film at a portion the covering layer is formed, and forming a getter layer by depositing a getter material from above the covering layer.

In the present invention, a pattern of the covering layer containing the component melting or oxidizing the metal film and the heat resistant fine particles respectively is formed on the metal back layer, and thereby, the metal film where the pattern is formed is melted/removed, or increased a resistance thereof, and an electrically divided portion is formed at the metal back layer. In addition, a discharge current is suppressed and a voltage resistance characteristic is improved because the getter layer formed on the metal back layer in the film shape, is divided by the covering layer containing the above-stated heat resistant fine particles.

Besides, it is possible to obtain a desired voltage resistance characteristic only by forming the covering layer in a single structure, and therefore, the number of processes is eliminated and a manufacturing efficiency is drastically improved compared to the prior art. In addition, an image display device having stable and fine characteristics in which a variation of characteristics is small can be obtained. Further, the number of process times on the metal back layer is reduced, and therefore, a damage received by the metal back layer can be suppressed to the minimum, and a formation of a new discharge trigger can be prevented.

### BRIEF DESCRIPTION OF DRAWINGS

FIG. 1 is a cross-sectional view schematically showing a structure of an FED which is an embodiment of an image display device according to the present invention.

FIG. 2 is a cross-sectional view enlargedly showing a face plate in the embodiment of the present invention.

### BEST MODE FOR CARRYING OUT THE INVENTION

Hereinafter, an embodiment according to the present invention will be described. It should be noted that the present invention is not limited to the following embodiment.

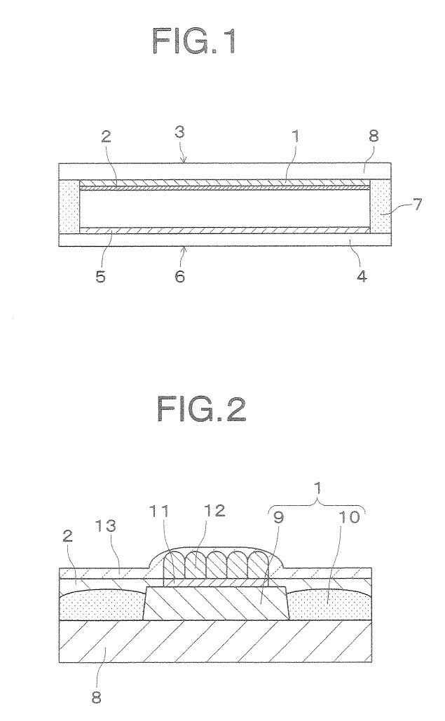

FIG. 1 is a cross-sectional view schematically showing a structure of an FED being an embodiment of the present invention.

This FED includes a face plate 3 having a phosphor screen 1, a metal back layer 2 formed on the phosphor screen 1, and further a getter layer (not shown) formed on the metal back layer, and a rear plate 6 having electron emission elements (for example, surface conduction-type electron emission elements) 5 arranged on a substrate 4 in a matrix state. The face plate 3 and the rear plate 6 are disposed to face with a gap of 1 mm to several mm with a support frame 7 and a spacer (not shown). The face plate 3 and the rear plate 6 are sealed and fixed to the support frame 7 with a joining material such as frit glass (not shown). A vacuum envelope is formed by the face plate 3, the rear plate 6, and the support frame 7, and inside thereof is evacuated. Besides, it is constituted so that a high voltage of 5 kV to 15 kV is applied to the extremely narrow gap between the face plate 3 and the rear plate 6. Incidentally, a reference numeral 8 in the drawing denotes a glass substrate.

A structure of the face plate 3 is enlarged and shown in FIG. 2. In FIG. 2, a light absorption layer 9 composed of a light absorption substance such as carbon, and having a predetermined pattern (for example, a stripe state) is formed at an inner surface of the glass substrate 8 by a printing method, a photolithography method, and so on. A phosphor layer 10 in three colors of red (R), green (G), and blue (B) is formed by a slurry method using a phosphor slurry of ZnS base, Y₂O₃ base, Y₂O₂S base, and so on in a predetermined pattern between this light absorption layers 9. The phosphor screen 1 includes the pattern of the light absorption layer 9 and the pattern of the three colors phosphor layer 10 as stated above.

Incidentally, the phosphor layer 10 of respective colors can be formed by a spray method and a printing method. A patterning by the photolithography method can be used together in the spray method and the printing method if necessary.

In the light absorption layer 9, it is desirable that at least a portion positioning at a lower layer of an electrically divided portion of a metal back layer which is later described has a surface resistance of 1×10⁵Ω/□ to 1×10¹²Ω/□. The divided portion of the metal back layer is connected with the above-stated resistance value in the structure in which the electrically divided portion of the metal back layer is formed on a region having the surface resistance as stated above, and therefore, an improvement effect of a voltage resistance characteristic becomes large. When the surface resistance of the light absorption layer 9 is less than 1×10⁵Ω/□, an electrical resistance between the divided metal back layers becomes too low, and therefore, a divided effect of a discharge prevention and a suppression of a peak value of a discharge current cannot be fully obtained. When the surface resistance of the light absorption layer 9 is over 10¹²Ω/□, an electrical connection between the divided metal back layers becomes insufficient, and it is not preferable from a point of view of the voltage resistance characteristic.

The metal back layer 2 composed of a metal film such as an Al film is formed on the phosphor screen 1 constituted by the pattern of the light absorption layer 9 and the pattern of the three colors phosphor layer 10. To form the metal back layer 2, a method (lacquer method) in which the metal film such as the Al film is vacuum evaporated on a thin layer composed of an organic resin such as nitrocellulose formed by, for example, a spin method, and further, a heating process (baking) is performed to decompose and remove organic constituents can be adopted.

Besides as shown in the following, the metal back layer 2 can also be formed by a transfer method using a transfer film. The transfer film has a structure in which the metal film such as Al and an adhesive layer are sequentially laminated on a base film via a release agent layer (protective film if necessary). This transfer film is disposed so that the adhesive layer is in contact with the phosphor screen, and a pressing process is performed while heating. As a pressing method, there are a stamp method, a roller method, and so on. The transfer film is pressed while heated as stated above, the base film is peeled off after the metal film is adhered, and thereby, the metal film is transferred on the phosphor screen. After the transfer, the heating process (baking) is performed to decompose and remove the organic constituents, and the metal back layer is formed.

In the embodiment of the present invention, an electrically divided portion 11 is formed in a predetermined pattern in the metal back layer 2 formed as stated above. Incidentally, it is desirable that the divided portion 11 of the metal back layer 2 is to be provided on the light absorption layer 9 to obtain a phosphor surface with high brightness. At the divided portion 11, a covering layer 12 containing a component melting or oxidizing Al which is a metal composing the metal back layer 2 (hereinafter, referred to as a metal melting/oxidizing component) and heat resistant fine particles respectively is formed.

Here, as the metal melting/oxidizing component, an acidic substance with a pH of 5.5 or less or an alkaline substance with a pH of 9 or more can be cited. As the acidic substance, hydrochloric acid, nitric acid, dilute sulfuric acid, phosphoric acid, oxalic acid, acetic acid, and so on are exemplified, and they are used in an aqueous solution state. Besides, as the alkaline substance, sodium hydroxide, potassium hydroxide, calcium hydroxide, sodium carbonate, and so on are exemplified, and they are used in the aqueous solution state. Incidentally, not only the case when the covering layer 12 formed at the divided portion 11 directly contains these substances, but also the case when these substances are generated by heating are to be included.

As the heat resistant fine particles, the one having an insulating characteristic, and a resistance for a high temperature heating such as a sealing process, can be used without particularly limiting a sort thereof. For example, fine particles of oxide such as SiO₂, TiO₂, Al₂O₃, Fe₂O₃ can be cited, and one or two or more kinds of these can be combined to use.

An average particle size of the heat resistant fine particle is desirable to be 5 nm to 30 μm, and more preferably, it is to be in a range of 10 nm to 10 μm. When the average particle size of the heat resistant fine particle is less than 5 nm, concaves and convexes are rarely formed on a surface of the covering layer 12. As a result, when a deposition film of a getter material is formed on the metal back layer 2 as stated below, the getter film is deposited also on the covering layer 12, and therefore, it becomes difficult to form the divided portion at the getter layer. When the average particle size of the heat resistant fine particle is over 30 μm, a formation in itself of the covering layer 12 becomes impossible.

As a method to form the covering layer 12, a method in which a liquid containing both the metal melting/oxidizing component and the heat resistant fine particles is coated by an ink jet method, or a spray method using a mask which has an opening pattern can be used. Besides, a binder resin, a solvent, and so on are added to this liquid to make it a paste state, and to be screen printed.

Here, a region in which the covering layer 12 containing the metal melting/oxidizing component and the heat resistant fine particles is formed, is the divided portion 11 of the metal back layer 2, and it is positioned at an upper portion of the light absorption layer 9. Therefore, there is an advantage that a brightness lowering of the heat resistant fine particles caused by an electron beam absorption is small. A width of the pattern of the covering layer 12 is desirable to be 50 μm or more, more preferably, 150 μm or more, and equal to or less than the width of the light absorption layer 9. When the pattern width of the covering layer 12 is less than 50 μm, an effect to divide the getter film can not be obtained sufficiently. Besides, when the pattern width is over the width of the light absorption layer 9, the covering layer 12 lowers a light emission efficiency of the phosphor surface, and therefore, it is not preferable.

The liquid or the paste containing the metal melting/oxidizing component and the heat resistant fine particles is coated at the predetermined region (for example, at the upper portion of the light absorption layer 9) on the metal back layer 2, the heating process (baking) is performed, and thereby, the metal film of the metal back layer 2 is melted or increased a resistance thereof to be electrically divided by the metal melting/oxidizing component contained in the liquid or paste, and the covering layer 12 derived from the coating layer of the above-stated liquid or paste is formed at this divided portion 11. In this covering layer 12, the heat resistant fine particles are contained as a main constituent, and therefore, fine concaves and convexes corresponding to diameters of these heat resistant fine particles are formed on a surface of the covering layer 12

Further, in the embodiment of the present invention, a deposition and so on of the getter material are performed from above the covering layer 12 containing the heat resistant fine particles and having the concaves and convexes on the surface. A deposition layer of the getter material is formed on a film only at the region where the covering layer 12 is not formed, and as a result, a getter layer 13 in a film shape having a pattern inverted to the pattern of the covering layer 12 is formed on the metal back layer 2. As stated above, the getter layer 13 in the film shape divided by the pattern of the covering layer 12 containing the heat resistant fine particles is formed.

As the getter material, a metal selected from Ti, Zr, Hf, V, Nb, Ta, W, and Ba, or an alloy in which a main constituent thereof is at least one kind of these metals, can be used. Besides, after the getter layer 13 is formed by the deposition of the getter material, the getter layer 13 is constantly held in a vacuum atmosphere to prevent a deterioration of the getter material. Consequently, after the pattern of the covering layer 12 containing the heat resistant fine particles and so on is formed on the metal back layer 2, it is desirable that a vacuum envelope is assembled to thereby dispose the phosphor screen 1 inside of the vacuum envelope and the deposition process of the getter material is performed inside of the vacuum envelope.

In the embodiment of the present invention, since the pattern of the covering layer 12 containing the component melting or oxidizing the metal (Al) film and the heat resistant fine particles respectively is formed on the metal back layer 2, the metal film is melted/removed or increased a resistance thereof. The electrically divided portion 11 is thereby formed at the metal back layer 2, and the getter layer 13 in the film shape which is deposited and formed on the metal back layer 2 is divided by the covering layer 12 formed at this divided portion 11. Consequently, a dividing effect of the metal back layer 2 is not lost by the formation of the getter layer 13, and a fine voltage resistance characteristic is secured.

In addition, a surface resistance value of the light absorption layer 9 positioning at a lower layer of the divided portion 11 is controlled to be a predetermined value, and the divided metal back layer 2 is electrically connected with this resistance value, and therefore, the voltage resistance characteristic is further improved.

Further, it is possible to obtain a desired voltage resistance characteristic only by forming the covering layer 12 in a single structure, and therefore, the number of processes is reduced and a manufacturing efficiency is drastically improved compared to the convention, and the image display device having stable and fine characteristics in which a variation of characteristics is small can be obtained. Further, the damages of the metal back layer 2 can be suppressed to the minimum because the number of times of processing on the metal back layer 2 is eliminated, and therefore, it is possible to prevent a formation of a new discharge trigger and to maintain the fine voltage resistance characteristic.

In the FED of the present embodiment, the divided portion 11 of the metal back layer 2 is limited to the region corresponding to the light absorption layer 9, the covering layer 12 containing the heat resistant fine particles and so on is formed at this region, and therefore, the high brightness display can be obtained because a reflection effect of the metal back layer 2 is rarely eliminated and a deterioration of a light emission efficiency caused by the formation of the covering layer 12 does not occur.

### EXAMPLES

Next, concrete examples in which the present invention is applied to an FED are described.

### Example 1

A carbon paste having the following composition was screen printed on a glass substrate, and thereafter, it was heated and baked at 450° C. for 30 minutes to decompose and remove organic constituents, and a light absorption layer in a stripe state was formed. When a surface resistance value of this light absorption layer was measured, it was 1×10⁷Ω/□. Subsequently, a three colors phosphor layer of red (R), green (G), and blue (B) was formed by a slurry method, and a phosphor screen in which the three colors phosphor layer in the stripe state was arranged so that they were respectively adjacent between the light absorption layer, was formed.

[Composition of carbon paste]

| | | |
|---|---|---|
| Carbon particle | 30 | wt % |
| Resin (ethyl cellulose) | 7 | wt % |
| Solvent (butyl carbitol acetate) | 63 | wt % |

Next, a metal back layer was formed on this phosphor screen by a transfer method. Namely, Al transfer film in which an Al film was laminated on a base film made of polyester resin via a release agent layer, an adhesive layer was coated and formed on the Al film was disposed on the phosphor screen so that the adhesive layer was in contact with the phosphor screen, and it was heated and pressurized to be in close contact by a heating roller from above that. Subsequently, the base film was peeled off to adhere the Al film on the phosphor screen, and thereafter, a pressing process and a baking process were respectively performed to the Al film. A substrate (8) in which a metal back layer was transferred and formed on the phosphor screen was obtained as stated above.

Next, a temperature of the substrate (A) was held at 50° C., a paste containing acid and silica component having the following composition (hereinafter, referred to as an acid/silica paste) was screen printed at a position corresponding to above the light absorption layer on the Al film, and thereafter, a heating process (baking) was performed at 450° C. for 30 minutes

[Composition of acid/silica paste]

| | | |
|---|---|---|
| Acetate aqueous solution (pH 5.5 or less) | 30 | wt % |
| Silica fine particle (particle size 3.0 μm) | 20 | wt % |
| Resin (ethyl cellulose) | 4 | wt % |
| Solvent (butyl carbitol acetate) | 46 | wt % |

The Al film of a paste coating portion was melted by a coating of the acid/silica paste and the baking after that, a divided portion in a stripe state was formed in the metal back layer composed of the Al film, and a covering layer containing silica fine particles as a main constituent thereof was formed to cover this divided portion.

Next, a substrate (B) (the substrate in which the covering layer containing the silica fine particles was formed at the divided portion of the metal back layer) obtained as stated above was used as a face plate, and an FED was fabricated by an ordinary method. At first, an electron emission source in which a number of surface conduction electron emission elements were formed on a substrate in a matrix state was fixed to a rear glass substrate to fabricate a rear plate. Subsequently, this rear plate and the above-stated face plate (substrate (B)) were disposed facing each other via a support frame and a spacer, and they were fixed and sealed by a frit glass. A gap between the face plate and the rear plate was set as 2 mm. Subsequently, after an evacuation, Ba was evaporated toward an inner surface of the face plate to deposit Ba on the covering layer containing the silica fine particles as the main constituent.

As a result, Ba being a getter material was deposited on the covering layer containing the silica fine particles as the main constituent, but a uniform film was not formed. On the contrary, a uniform deposition film of Ba was formed at a region in which the covering layer was not formed on the metal back layer. A Ba getter layer in a film shape divided by the covering layer containing the silica fine particles as the main constituent was formed. After that, the FED was completed by performing required processes such as a sealing.

### Example 2

A paste containing a black pigment instead of the carbon particle was used to thereby form a light absorption layer having a surface resistance value of 1×10¹⁴Ω/□ on a glass substrate. A face plate was fabricated as same manner as in Example 1 and an FED was completed.

As a comparative example, a face plate was fabricated as stated below, and an FED was completed as same manner as in the example 1 by using the face plate. Namely, as same as in Example 2, after a light absorption layer (surface resistance value of 1×10¹⁴Ω/□) was formed on a glass substrate by using a black pigment, a metal back layer was formed on a phosphor screen. Subsequently, an acid paste composed of an acetate aqueous solution (pH 5.5 or less), resin (ethyl cellulose), and solvent (butyl carbitol acetate) was coated at a position corresponding to above the light absorption layer on the Al film by a screen print, and thereafter, a baking was performed at 450° C. for 30 minutes to for a divided portion.

Thereafter, a carbon paste having a composition shown in the following was screen printed on the divided portion of the metal back layer. Organic constituents were decomposed and removed by heating and baking at 450° C. for 30 minutes to form a covering lower layer. When a surface resistance value of this covering lower layer was measured, it was 1×10⁷Ω/□.

[Composition of carbon paste]

| | | |
|---|---|---|
| Carbon particle | 30 | wt % |
| Resin (ethyl cellulose) | 7 | wt % |
| Solvent (butyl carbitol acetate) | 63 | wt % |

Next, a silica paste having the following composition was screen printed on this covering lower layer, and the baking was performed at 450° C. for 30 minutes. A substrate in which the silica particles layer was formed on the high resistance covering lower layer was obtained. This substrate was made to be a face plate, and an FED was fabricated as same manner as in Example 1.

[Composition of silica paste]

| | | |
|---|---|---|
| Silica particle (particle size 3.0 μm) | 20 | wt % |
| Low melting glass particle (SiO₂•B₂O₃•PbO) | 20 | wt % |
| Resin (ehtyl cellulose) | 6 | wt % |
| Solvent (butyl carbitol acetate) | 54 | wt % |

Discharge voltages, discharge currents of the FEDs respectively obtained at Example 1, Example 2, and Comparative Example were measured by an ordinary method. Besides, the FEDs in Example 1, Example 2, and Comparative Example were fabricated 10 for each with the same specification, and variations of the discharge current were measured and evaluated. Measured results are shown in Table 1.

TABLE 1

| | EXAMPLE | EXAMPLE | COMPARATIVE |
|---|---|---|---|
| | 1 | 2 | EXAMPLE |
| INITIAL | 11 | 10 | 6 |
| DISCHARGE | | | |
| VOLTAGE (kV) | | | |
| VOLTAGE | 14 | 12 | 12 |
| RESISTANCE | | | |
| CHARACTERISTIC | | | |
| (kV) | | | |
| DISCHARGE | 2 to 3 | 10 to 11 | 2 to 7.5 |
| CURRENT (A) | | | |
| VARIASION OF | 1 | 1 | 5.5 |
| DISCHARGE | | | |
| CURRENT (A) | | | |

As it is obvious from Table 1, it is found that the values of the initial discharge voltage and the voltage resistance characteristic (maximum withstand voltage) of the FEDs obtained by the example 1 and example 2 are enhanced, and the variations of the values of the discharge are small to show they have stable and fine characteristics compared to the FED of the comparative example. In particular, in the FED of the example 1, the divided portion of the metal back layer is connected via the light absorption layer having the surface resistance of 1×10⁷Ω/□, and therefore, the discharge current value is suppressed drastically.

### INDUSTRIAL APPLICABILITY

According to the present invention, it is possible to obtain an image display device in which a discharge current is suppressed and a voltage resistance characteristic is excellent. This image display device is particularly suitable for an FED. Besides, the number of processes is reduced compared to the convention, and therefore, a manufacturing efficiency is drastically improved, and further, stable and fine characteristics in which a variation of characteristics is small can be obtained.

1. An image display device, comprising:
a face plate having a phosphor screen including a light absorption layer and a phosphor layer which are formed in a predetermined pattern on a glass substrate, and a metal back layer formed on the phosphor screen; and
a rear plate having a number of electron emission elements formed on a substrate, and disposed to face the face plate,
wherein the metal back layer includes an electrically divided portion formed in a predetermined pattern, a covering layer containing a component melting or oxidizing a metal material composing the metal back layer and heat resistant fine particles respectively, and having concaves and convexes at a surface resulting from the heat resistant fine particles, is formed in the divided portion, and a getter layer divided by the covering layer is formed on the metal back layer in a film shape.

2. The image display device as set forth in claim 1, wherein the electrically divided portion of the metal back layer is positioned on the light absorption layer.

3. The image display device as set forth in claim 1, wherein the component melting or oxidizing the metal material composing the metal back layer is an acidic substance with a pH of 5.5 or less or an alkaline substance with a pH of 9 or more.

4. The image display device as set forth in claim 2, wherein in the light absorption, layer, at least a portion positioning at a lower layer of the electrically divided portion of the metal back layer has a surface resistance of 1×10⁻⁵Ω/□ to 1×10¹²Ω/□.

5. The image display device as set forth in claim 1, wherein an average particle size of the heat resistant fine particle is from 5 nm to 30 μm.

6. The image display device as set forth in claim 1, wherein the heat resistant fine particles are at least one kind of particles of oxide selected from SiO₂, TiO₂, Al₂O₃, and Fe₂O₃.

7. The image display device as set forth in claim 1, wherein the getter layer is a metal layer selected from Ti, Zr, Hf, V, Nb, Ta, W, and Ba, or an alloy layer of which a main constituent is at least one kind of metal selected from these metals.

8. A manufacturing method of an image display device, comprising:
forming a phosphor screen in which a light absorption layer and a phosphor layer are arranged in a predetermined pattern at an inner surface of a face plate;
forming a metal back layer by forming a metal film on the phosphor screen;
forming a vacuum envelope including the face plate; and
disposing an electron emission source inside of the vacuum envelope to face the phosphor screen,
wherein the manufacturing method of the image display device includes forming a covering layer containing a component melting or oxidizing the metal film and heat resistant fine particles respectively at a predetermined region on the metal back layer composed of the metal film, and removing or increasing a resistance of the metal film at a portion the covering layer is formed, and forming a getter layer by depositing a getter material from above the covering layer.

9. The manufacturing method of the image display device as set forth in claim 8, wherein the getter layer in a film shape is formed at a non-forming region of the covering layer on the metal back layer in forming the getter layer.

10. The image display device as set forth in claim 5, wherein the heat resistant fine particles are at least one kind of particles of oxide selected from SiO₂, TiO₂, Al₂O₃, and Fe₂O₃.
